(19) United States
(12) Patent Application Publication
(10) Pub. No.: US 2015/0122956 A1
(43) Pub. Date: May 7, 2015

(54) RETENTION UNIT TO GRASP A FLEXIBLE HOSE AND CLAMP ONTO BED SHEETS AND METHODS OF MANUFACTURE AND OPERATION THEREOF

(71) Applicant: Mark Aramli, Newport, RI (US)

(72) Inventor: Mark Aramli, Newport, RI (US)

(21) Appl. No.: 14/534,736

(22) Filed: Nov. 6, 2014

Related U.S. Application Data
(63) Continuation-in-part of application No. 29/501,652, filed on Sep. 5, 2014.
Application No. 29/501,652 is a continuation-in-part of application No. 29/501,656, filed on Sep. 5, 2014.
Application No. 29/501,656 is a continuation-in-part of application No. 29/501,647, filed on Sep. 5, 2014.
(60) Provisional application No. 61/966,042, filed on Nov. 6, 2013.

(51) Int. Cl. F16L 3/00; A47C 21/02; F16L 3/02; A47C 21/04

(52) U.S. Cl. CPC F16L 3/003; A47C 21/04; A47C 21/022; F16L 3/02
USPC 248/70

(57) ABSTRACT

A retention unit that grasps a periphery of a flexible hose and that clamps onto bed sheets to prevent relative movement of the hose and bed sheets where the grasping and clamping takes place. The retention unit includes a grasping portion, a fixing portion, a rising portion and a fixing portion. The rising portion may have at least two pieces mounted in a sliding manner to slide relative to each other so as to separate the grasping portion and the fixing portion from each other and different elevations. The two pieces may be slid relative to each other and held against further relative movement by securing them. The fixing portion is positioned underneath a mattress.

### CROSS-REFERENCE TO COPENDING PATENT APPLICATIONS

This patent application asserts the benefit of invention priority from the filing on Nov. 6, 2013 of U.S. provisional patent application No. 61/966,042 entitled “Forced air thermal device for a bed with integrated wireless RF remote controls and optional wi-fi/Bluetooth controls”.

### INCORPORATION BY REFERENCE TO COPENDING PATENT APPLICATIONS

This patent application incorporates subject matter by reference to copending patent applications of the same inventor as that of the present application:

(1) U.S. provisional patent application No. 61/966,042 entitled “Forced air thermal device for a bed with integrated wireless RF remote controls and optional wi-fi/Bluetooth controls.

(2) U.S. design patent application Ser. No. 29/501,652 filed Sep. 5, 2014 entitled “AIR DELIVERY OUTLET NOZZLE”.

(3) U.S. design patent application Ser. No. 29/501,656 filed Sep. 5, 2014 and entitled “HOUSING FOR A CLIMATE CONTROL APPARATUS”.

(4) U.S. design patent application Ser. No. 29/501,647 filed Sep. 5, 2014 and entitled “SLEEVED HOSE”.

(5) U.S. utility patent application filed on Nov. 6, 2014 and entitled “REMOTE SETTING AND OPERATION OF A BEDDING CLIMATE CONTROL APPARATUS WITH FORCED AIRFLOW FOR HEATING AND VENTILATING.

(6) U.S. utility patent application filed on Nov. 6, 2014 and entitled “BEDDING CLIMATE CONTROL APPARATUS WITH FORCED AIRFLOW FOR HEATING AND VENTILATING”.

### BACKGROUND OF THE INVENTION

### Technical Field of the Invention

The invention is a retention unit that is held stationary beneath a mattress and clamps to bed sheets and grasps a flexible hose that delivers tempered air.

### BRIEF DESCRIPTION OF THE DRAWING

For a better understanding of the present invention, reference is made to the following description and accompanying drawings, while the scope of the invention is set forth in the appended claims.

FIG. 1 is an isometric view the top, rear and left side of the bed sheet retention unit in accordance with an embodiment of the invention that includes a fixing portion, an adjustable rising portion, a grasping portion and a clamping portion.

FIG. 2 is a cross-section of the grasping portion taken across section line 2-2 of FIG. 1.

FIG. 3 1 is an isometric view of the top, front and right side of the bed sheet retention unit in accordance with the invention of FIG. 1.

FIG. 4 is an isometric view of a non-adjustable bed sheet retention unit in accordance with a further embodiment of the invention.

FIG. 5 is a schematic view of the assembly of an air delivery outlet nozzle secured to a distal end of a longitudinally compressible/expandable hose, whose proximal end is secured to a discharge port of the bedding climate control apparatus and the bed sheet retention unit of FIG. 3 clamped to sheets for a conventional bed having a box spring and mattress.

FIG. 6 is a schematic view of the assembly of the air delivery outlet nozzle secured to a distal end of a longitudinally compressible/expandable hose, whose proximal end is secured to a discharge port of the bedding climate control apparatus with the bed sheet retention unit of FIG. 3 clamped to sheets for a conventional partition bed.

### DETAILED DESCRIPTION OF THE INVENTION

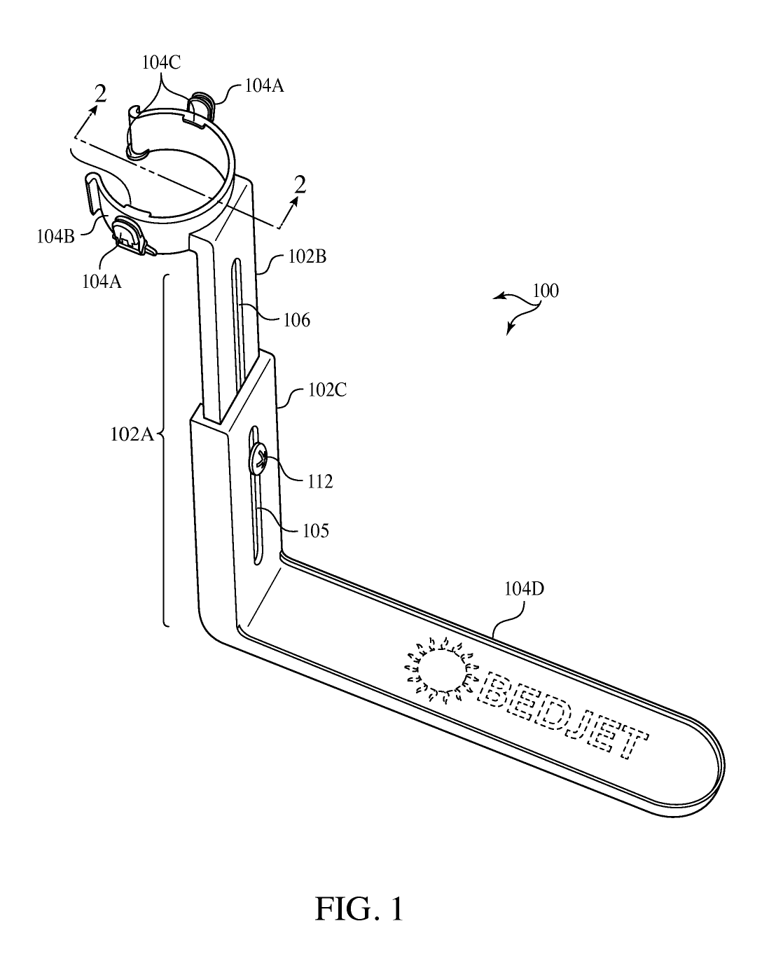

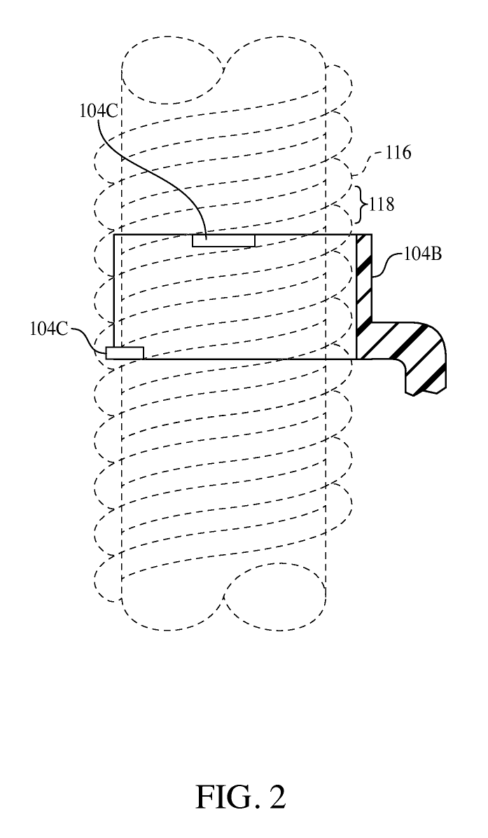

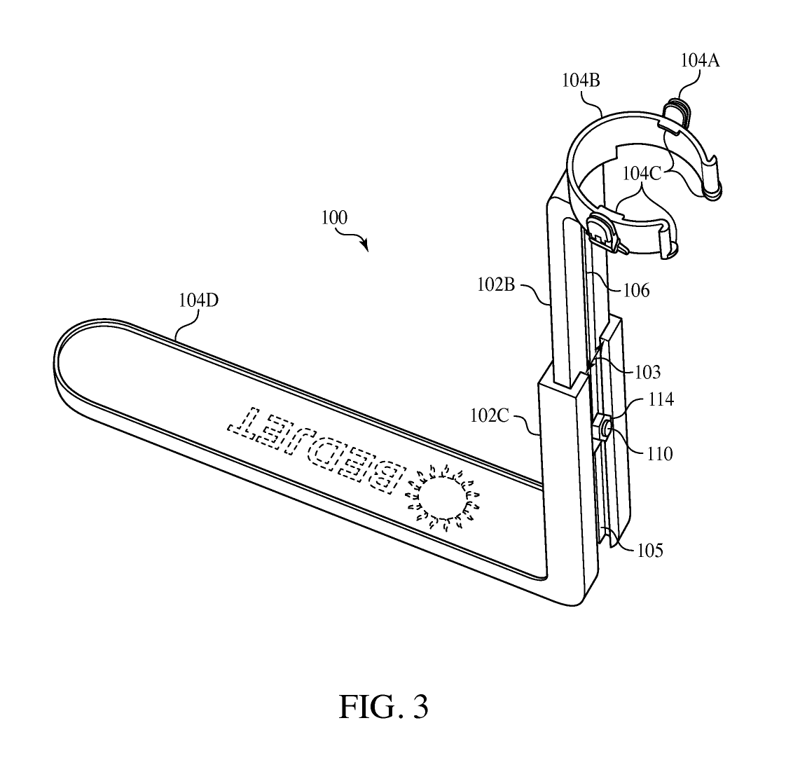

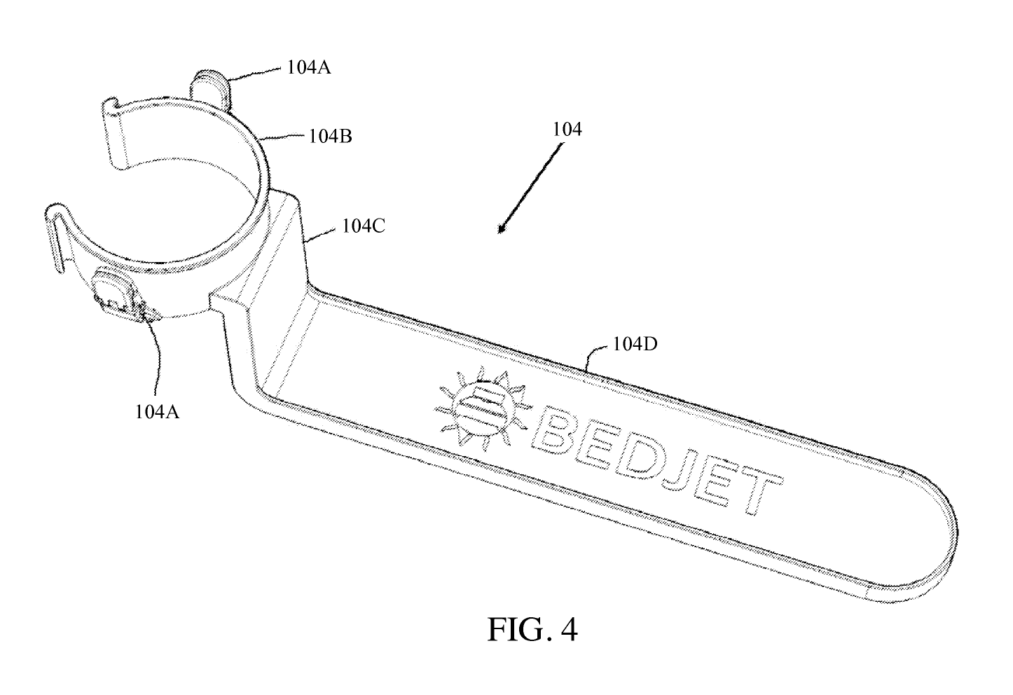

Turing to the drawing, FIGS. 1 and 3 show an adjustable bed sheet retention unit 100 and FIG. 4 shows a non-adjustable bed sheet retention unit 104. Each has means for clamping a bed sheet, namely, at least two clamps 104A, which may be diametrically opposite each other on a horizontally extending grasping portion that also includes means for holding the flexible hose 116, (FIG. 2), namely, a horizontally extending ring-shaped segment 104B (FIGS. 1, 2, 4). As shown in FIG. 2, the flexible hose 116 will fit within the internal opening defined by the ring-shaped segment 104B. Preferably, the ring-shaped segment 104B has inwardly directed projections or flanges 104C that are configured to enter a spiraling groove 118 in the exterior of the flexible hose 116.

In the case of FIGS. 1 and 3, there is a vertically extending riser segment 102A (or rising portion) that has at least two pieces 102B, 102C that telescope one within the other or otherwise slide relative to each other to move through a plurality or relative positions. Indeed, the at least two pieces 102B, 102C may be retained at any desired one of the plurality of relative positions by exerting pressure to the at least two pieces 102B, 102C by extending a threaded stem 110 that extends from a wider screw head 112 to pass through aligned elongated slits or slots 105, 106 in each of the two pieces 102B, 102C to engage a nut 114 in a tightened manner so that the screw head 112 at the opposite end of the threaded screw stem and the nut press against outward facing surfaces of the two pieces 102B, 102C since both the screw head 112 and the nut 114 are wider than the slits or slots 105, 106.

Piece 102B is elongated and forms a recess 103 (FIG. 3) bordered by a rear surface 103A, two side surfaces 1038 projecting from the rear surface, and two front surfaces each projecting towards each other from respective ones of the side surfaces yet each terminating to define an opening between an edge of each of the two front surfaces. Piece 102C is dimensioned to fit within the recess 103 formed by the piece 102B and defines an elongated central slit or slot 105 in alignment with a corresponding elongated central slit or slot 106 in the piece 102B. Both slits or slots 105, 106 align with the recess 103 between the edges of the front surface of the piece 102B with the riser segment 102A in a retracted position. The threaded screw stem 110 fits through both elongated slits or slots 105, 106 with the screw head 112 being wider than the slit or slot 105, 106 and with the nut 114 being wider than the slit or slot 105, when screwed onto the threaded screw stem 110. Tightening the screw into the nut causes the screw head 112 and nut 114 to exert pressure against outward faces of respective ones of the two pieces 102B, 103C the help retain the two pieces 102B, 102C to each other.

In the case of FIG. 4, there is a vertically extending riser segment 104C (or rising portion) that rises vertically between and end of a horizontally extending base segment 104D and the ring-shaped segment 104B.

The ring-shaped segment 104 may be closed to grasp about a periphery of the hose to prevent horizontal movement of the flexible hose 116. If the ring-shaped segment 104 is corrugated on its inward facing side, the corrugations are sized to enter grooves on the exterior of the flexible hose 116 to retain the flexible hose 116 in position against relative vertical movement where the retention takes place.

The horizontally extending base segment 104D is elongated and will lie beneath a mattress and provides firm support for the performance of the retaining and holding functions. The vertically extending riser segment 104C extends along an end of the mattress at the foot of a bed. The vertically extending riser segment 104C may be height adjustable by being formed of two sliding elements that slide relative to each other vertically and secured in any relative position with respect to each other in any convention manner that two sliding pieces may be retained in their relative position with respect to each other, such as with a series of holes in one of the sliding pieces and a spring-loaded button in the other that enters into one of the series of holes when aligned and can be urged manually against spring bias to leave the hole to free the sliding pieces from their relative position.

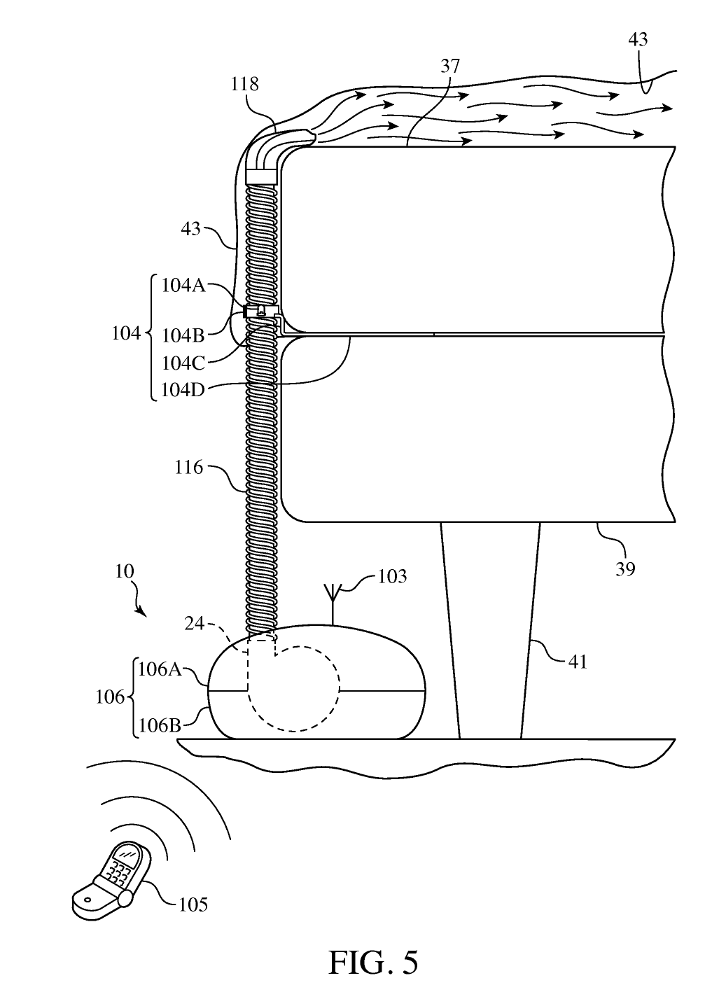

FIG. 5 shows the bedding climate control apparatus 10 on a floor beneath a bed to blow forced air through the flexible hose 116 and out the air delivery outlet nozzle 118 to enter space between a mattress 37, which would typically have a mattress fitted mattress sheet that covers the mattress 37 (i.e., the fitted mattress sheet covers the top, both sides, both ends and a portion of the underside of the mattress by opposite ends of the mattress), and a bed sheet 43 the overlays the fitted mattress sheet. The bed is partially shown, with its mattress 37 atop a box spring 39 elevated by a frame leg 41. The flexible hose 116 extends from the fan/blower discharge in the bedding climate control apparatus to rise to the air delivery outlet nozzle 118 at the foot of the bed. The bedding retention unit 104 (see FIG. 3) has its horizontally extending base segment 104D between the mattress 37 and the box spring 39. The vertically extending riser segment 104C (or rising portion) elevates the horizontally extending ring-shaped segment 104B. The two clamps 104A are clamped to the bed sheet 43 to keep the bed sheet in place to overlay the air delivery outlet nozzle 118 and thus prevent the bed sheet from being pushed to the side off the air delivery outlet nozzle 118 by a person's feet while laying in bed. The flexible hose 116 is retained by the horizontally extending ring-shaped segment 104B.

The bedding climate control apparatus 10 and the flexible hose 116 and the air delivery outlet nozzle 118 may be constructed and operated in accordance with that of U.S. utility patent application filed in November 2014 on the same day as that of the present application and entitled “REMOTE SETTING AND OPERATION OF A BEDDING CLIMATE CONTROL APPARATUS WITH FORCED AIRFLOW FOR HEATING AND VENTILATING, whose contents are incorporated herein by reference, and with that of U.S. utility patent application filed in November 2014 on the same day as that of the present application and entitled “BEDDING CLIMATE CONTROL APPARATUS WITH FORCED AIRFLOW FOR HEATING AND VENTILATING, whose contents are incorporated herein by reference. Further, the air delivery outlet nozzle 118 may be in accordance with by U.S. design patent application Ser. No. 29/501,652 filed Sep. 5, 2014 entitled “AIR DELIVERY OUTLET NOZZLE:, whose contents are incorporated herein by reference. Also, the housing for the bedding climate control apparatus 10 may be in accordance with U.S. design patent application Ser. No. 29/501,656 filed Sep. 5, 2014 and entitled “HOUSING FOR A CLIMATE CONTROL APPARATUS”, whose contents are incorporated herein by reference. In addition, the flexible hose 116 may be in accordance with U.S. design patent application Ser. No. 29/501,647 filed Sep. 5, 2014 and entitled “SLEEVED HOSE”, whose contents are incorporated herein by reference.

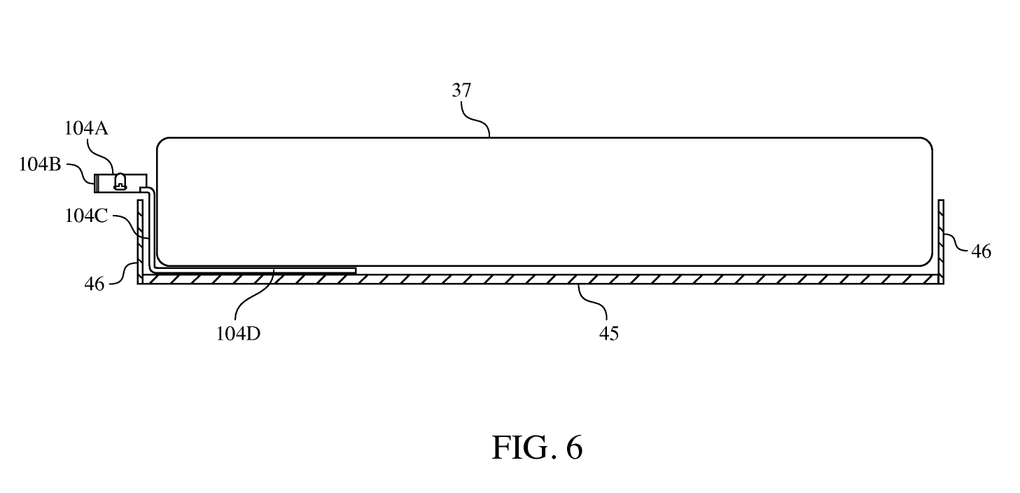

FIG. 6 shows a partial view of a platform bed 45 used in place of the box spring 39 and frame leg 41 of FIG. 5. The mattress 37 rests on a base of the platform bed 45 so that the bedding retention unit 104 is positioned in a like manner except that the horizontally extending base segment 104D lies between the underside of the mattress 37 and the topside of the base of the platform bed 45. Some platform beds have a peripheral lip 46 that extends upward about the periphery of the base. The vertically extending riser segment 104C elevates the horizontally extending ring-shaped segment 104B to an elevation higher than the top of the lip 46 region of the horizontally extending ring-shaped segment 104B that meets the top of the vertically extending riser segment 104C (or rising portion) clears the lip 46.

The flexible hose 116 is a kind of air conduit. Any air conduit may be utilized in accordance with the invention as a substitute for the flexible hose 116 that is shown regardless of the shape of its diametrical cross-section be it circular, rectangular, triangular, pentagonal, hexagonal, octagonal, etc. The air conduit may be considered to terminate into an open end portion as reflected by the air delivery outlet nozzle 118.

Although the drawings show a particular shape for the air outlet delivery nozzle 118, the invention is not limited to any particular shape such as that depicted. Instead, any conventional configuration with an opening for the discharge of airflow is envisioned.

The two clamps 104A may be of any configuration suited to retain the bed sheets in position that keeps the bed sheet overlaying the air outlet delivery nozzle 18.

The horizontally extending base segment 104D is a kind of fixing portion in that it fixes the relative position of the rest of the retention unit when it is in position underneath a mattress that rests upon a surface. Such a fixing portion may be of a one piece unitary construction as shown or be in multiple elongated pieces with each as long as that depicted for the base segment 104D but not as wide yet preferably arranged to lay side by side with each other.

The vertically extending riser segment 102A or rising portion may have a configuration different from that depicted in the drawing so long as they are retractable and expandable between fully withdrawn and fully extended positions. For instance, the two pieces may telescope one into the other with each being tubular.

Since the air conduit such as the flexible hose 116 is grasped, the two clamps 104A could be attached to the air conduit itself preferably in close proximity to where the ring-shaped segment 104 grasps the air conduit. In that case, the two clamps 104A would be separate from the ring-shaped segment 104 and from the vertically extending riser segment 102A or 104B as the case may be. The two clamps 104A could be attached to a separate ring that grasps the periphery of the air conduit in a manner analogous to that of the ring-shaped segment 104.

While the foregoing description and drawings represent the preferred embodiments of the present invention, various changes and modifications may be made without departing from the scope of the present invention.

What is claimed is:

1. A bedding climate control apparatus retention unit, comprising
a retention unit having:
grasping means for grasping, in a secure manner with a grasping portion, an air conduit that terminates into an open end portion;
fixing means for fixing, with a fixing portion, the air conduit into position with respect to a side of a bed against relative movement; and
clamping means for clamping, with a clamping portion, a bed sheet in a position extending over the open end portion of the air conduit even as said grasping means grasps the air conduit in the secure manner.

2. The apparatus of claim 1, wherein said retention unit also has a rising portion that separates the grasping and clamping portions from the fixing portion by a separation distance, said grasping and fixing portions extending from said rising portion in opposite directions relative to each other.

3. The apparatus of claim 2, wherein the rising portion has at least two pieces movable with respect to each other through a plurality of relative positions so as to vary an amount of the separation distance; and
releasable retaining means for releasably retaining the at least two pieces to each other to prevent the at least two pieces from moving relative to each other until manually released from each other.

4. The apparatus of claim 3, wherein the relative positions include fully retracted and fully extended positions, the at least two pieces being movable so as to slide relative to each other between the fully retracted and fully extended positions, the releasable retaining means including a fastener that is tightened to press against outward facing surfaces of the at least two pieces to releasably retain the at least two pieces in a fixed relative position to each other.

5. The apparatus of claim 4, wherein the at least two pieces have elongated slits or slots that are in alignment with each other, said releasable retaining means includes the fastener whose stem extends through both of the aligned slits or slots.

6. The apparatus of claim 1, wherein the grasping portion is configured to encircle and grasp onto a periphery of the air conduit, the grasping portion having a surface formation that projects into a groove on an exterior of the air conduit to block relative movement of the flexible hose with respect to the grasping portion.

7. The apparatus of claim 1, wherein both the grasping portion and the support portion extend into respective planes that are substantially parallel to each other, the rising portion extending substantially within a plane that intersects the respective planes.

8. A method to grasp a flexible hose and retain a bed sheet, comprising the steps of:
providing a retention unit having a grasping portion, a fixing portion and a clamping portion;
grasping, in a secure manner with the grasping portion an air conduit that terminates into an open end portion;
fixing, with the fixing portion, the air conduit into position with respect to a side of a bed against relative movement; and
clamping, with the clamping portion, a bed sheet in a position extending over open end portion of the air conduit even as the grasping portion grasps the air conduit in the secure manner.

9. The method of claim 8, further comprising:
separating said fixing portion from said grasping and clamping portion with a rising portion to define a separation distance, the grasping and the fixing portions each extending in opposite directions from the rising portion relative to each other.

10. The method of claim 8, further comprising
moving at least two pieces of the rising portion with respect to each other through a plurality of relative positions so as to vary an amount of the separation distance between the fixing portion and the grasping and clamping portions; and
retaining the at least two pieces to each other in a releasable manner to prevent the at least pieces from moving relative to each other until manually released from each other.

11. The method of claim 8, wherein the relative positions include fully retracted and fully extended positions, the moving including sliding the at least two pieces relative to each other between the fully retracted and fully extended positions; and
tightening a fastener to press against outward facing surfaces of the at least two pieces to carry out the retaining of the at least two pieces in a fixed relative position to each other.

12. The method of claim 11, further comprising inserting the fastener into elongated slits or slots of at least two pieces of the rising portion, the elongated slits of slot being in alignment with each other.

13. The method of claim 8, further comprising encircling and grasping a periphery of the air conduit with the grasping portion, the grasping portion having a surface formation that projects into a groove on an exterior of the air conduit to block relative movement of the flexible hose with respect to the grasping portion.

14. The method of claim 8, further comprising extending both the grasping portion and the fixing portion into respective planes that are substantially parallel to each other, extending the rising portion within a plane that intersects the respective planes.
